(19) United States
(12) Patent Application Publication
(10) Pub. No.: US 2026/0044687 A1
(43) Pub. Date: Feb. 12, 2026

(54) METHOD AND SYSTEM FOR OPERATING CONTENT TRANSLATION

(71) Applicant: NAVER WEBTOON Ltd., Seongnam-si (KR)

(72) Inventors: Jae Han Yoon, Seongnam-si (KR); Yu Jin Hong, Seongnam-si (KR); Ji Seon Sim, Seongnam-si (KR); Jun Eyoun Moon, Seongnam-si (KR); Jae Hyuk Jang, Seongnam-si (KR); Wan Been Joo, Seongnam-si (KR); Ji Ho Sung, Seongnam-si (KR); Kyong Min Noh, Seongnam-si (KR); Joo A Cha, Seongnam-si (KR); Ji Eun Lee, Seongnam-si (KR); Yu Jin Chung, Seongnam-si (KR); Young Sub Choi, Seongnam-si (KR); Ju Yul Park, Seongnam-si (KR); Ju Yeon Moon, Seongnam-si (KR)

(21) Appl. No.: 18/981,077

(22) Filed: Dec. 13, 2024

(30) Foreign Application Priority Data
Aug. 6, 2024 (KR) 10-2024-0104873

(51) Int. Cl. G06F 40/58; G06T 11/60

(52) U.S. Cl. CPC G06F 40/58; G06T 11/60

(57) ABSTRACT

A method of providing content translation that includes transmitting, by a management server, a translation target manuscript for an episode of content created based on a first language to a translation server; providing, by the translation server, the translation target manuscript to a first terminal, and receiving, from the first terminal, translated language corresponding to a second language, where the second language is different from the first language; generating, by the translation server, a translation file for the translation target manuscript using the received translated language; providing, by the translation server, the translation file to a second terminal; and receiving, from the second terminal, an image file corresponding to the episode, which is translated into the second language using the translation file.

### CROSS REFERENCE TO RELATED APPLICATION

The present application claims the priority of Korean Patent Application No. 10-2024-0104873, filed on Aug. 6, 2024, the entire contents of which are incorporated herein for all purposes by this reference.

### BACKGROUND OF THE INVENTION

### Field of the Invention

The present invention relates to a method of operating content translation and a system for supporting the same.

### Description of the Related Art

As technology advances, the use of digital devices increases. In particular, electronic devices (e.g., smartphones, tablet PCs, etc.) are equipped with various functions including communication functions, such as phone calls or text messages, as well as surfing the web, listening to music, and watching videos using the Internet.

With the popularization of electronic devices, consumption of contents provided through electronic devices, such as PCs or mobile devices, is rapidly increasing. For example, there are webcomics. A webcomic is a comic serialized and distributed through an Internet communication network.

As the consumption of these webcomics continues to increase, various service providers (or webcomic-related service providers) are developing various services to secure users (or consumers, subscribers) who can use the services steadily.

For example, Korean Laid-Open Patent No. 10-2018-0119005 (a webtoon providing method using a sharing function) discloses a method of allowing a user owning a webcomic online to share the webcomic with other users, where those other users can read part of the webcomic and decide whether to make a purchase, thereby enabling users to purchase webcomics containing content of their preference.

Such webcomics go beyond being created by authors and provided as a service in their respective countries, and they are now being serviced globally. Therefore, it is essential that they are translated into various languages of various different countries. As described above, in order to enhance consumer purchase intent for content on a global scale, customized translation for each country is necessary. However, a systematic translation process for webcomics has not yet been established.

### SUMMARY OF THE INVENTION

The present invention relates to a method and a system for providing content translation, which establishes a systematic translation system for content, thereby enabling users from a plurality of countries to continuously use the content. More specifically, the present invention is directed to a method of implementing a system that supports content translation and of operating the same.

In particular, the present invention relates to a method and system for providing content translation that provides functions necessary for the content translation and enables task process management.

Further, the present invention relates to a method of more systematically managing the translation task of a translator.

In order to solve the challenges reviewed above, there is a method of providing content translation, according to at least one embodiment of the present invention. The method may include: transmitting, by a management server, a translation target manuscript for an episode of content created based on a language of a first country to a translation server; providing, by the translation server, the translation target manuscript to a first terminal, and receiving, from the first terminal, translated language corresponding to a language of a second country different from the language of the first country based on the translation target manuscript; generating, by the translation server, a translation file for the translation target manuscript using the received translated language; providing, by the translation server, the translation file to a second terminal; and receiving, from the second terminal, an image file corresponding to the episode, which is translated into the language of the second country using the translation file.

There is provided a system for providing content translation according to at least one embodiment of the present invention. The system may include a management server configured to register a translation target manuscript for an episode of content created based on a language of a first country, and a translation server configured to receive the translation target manuscript from the management server, and provide the translation target manuscript to a first terminal that translates the translation target manuscript into a language of a second country different from the language of the first country, in which the translation server receives a translated language corresponding to the language of the second country from the first terminal, generates a translation file for the translation target manuscript using the received translated language and provides the translation file to the second terminal, and receives an image file corresponding to the episode, which is translated into the language of the second country, from the second terminal and transmits a translated episode for the episode to the management server.

There is a program executed by one or more processes in an electronic device and stored in a non-transitory computer-readable recording medium, according to at least one embodiment of the present invention. The program may include instructions to allow the program to perform: transmitting, by a management server, a translation target manuscript for an episode of content created based on a language of a first country to a translation server; providing, by the translation server, the translation target manuscript to a first terminal, and receiving, from the first terminal, translated language corresponding to a language of a second country different from the language of the first country based on the translation target manuscript; generating, by the translation server, a translation file for the translation target manuscript using the received translated language; providing, by the translation server, the translation file to a second terminal; and receiving, from the second terminal, an image file corresponding to the episode, which is translated into the language of the second country using the translation file.

As described above, a method and system for providing content translation according to at least one embodiments of the present invention consists of a management server and a translation server so that the entire process of providing services to other countries may be performed more systematically and consistently by translating the original webcomic. That is, according to the present invention, it is possible to more systematically manage cooperation between a webcomic service provider, a translation provider, and a manager by efficiently designing the data processing flow between various entities.

Further, a method and system for providing content translation according to the present invention may provide the translation target manuscript to the first terminal by the translation server, and receive translated language corresponding to the language of a second country different from the language of the first country based on the translation target manuscript from the first terminal. A user of the first terminal is provided with an efficient translation environment optimized for translation by the translation server, and the translation server may receive translation results translated from the language of the first country to the language of the second country from the first terminal.

Further, a method and system for providing content translation according to the present invention may generate a translation file for the translation target manuscript using the translated language received by the translation server, and provide a translation file to the second terminal by the translation server. A user of the second terminal can intuitively recognize and match the translated language and an episode of the original work content through the translation file, and perform lettering task.

Further, a method and system for providing content translation according to at least one embodiment of the present invention may receive an image file corresponding to the episode and translated into the language of the second country using the translation file from the second terminal, and provide contents translated into various languages to consumers.

### BRIEF DESCRIPTION OF THE DRAWINGS

FIG. 1 is a diagram for explaining a system for performing content translation according to an embodiment of the present invention.

FIG. 2A and FIG. 2B are flowcharts for explaining a method of performing content translation according to an embodiment of the present invention.

FIG. 3A and FIG. 3B are flowcharts for explaining data flow according to a method of performing content translation in the described embodiment of the present invention.

FIG. 4A, FIG. 4B, FIG. 4C, and FIG. 4D are diagrams for explaining an operator account and a manager account according to the described embodiment of the present invention.

FIG. 5A, FIG. 5B, FIG. 5C, FIG. 5D, and FIG. 5E are diagrams for explaining translation, reviewing, and lettering processes according to the described embodiment of the present invention.

### DETAILED DESCRIPTION OF THE INVENTION

Hereinafter, exemplary embodiments disclosed in the present specification will be described in detail with reference to the accompanying drawings. The same or similar constituent elements are assigned the same reference numerals, and the repetitive description thereof will be omitted. The terms “module”, “unit”, “part”, and “portion” used to describe constituent elements in the following description are used together or interchangeably in order to facilitate the description, but the terms themselves do not have distinguishable meanings or functions. In addition, in the descriptions of the exemplary embodiments disclosed in the present specification, the specific descriptions of publicly known related technologies will be omitted when it is determined that the specific descriptions may obscure the subject matter of the exemplary embodiments disclosed in the present specification. In addition, it should be understood that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

The embodiments of the present invention relate to a method of performing content translation and a system therefor, which may provide a function interface (such as a graphical user interface, or GUI) necessary for translation, lettering, and review tasks of content, in linkage with content provision services, as well as a communication tool (e.g., Inbox, Message) between task operators.

The types of content to which the embodiments of the present invention may be applied may be highly diverse. For example, at least one type of content, such as webcomics, web novels, music, e-books, videos, or images, may correspond to the content provided in the examples of the present invention.

Hereinafter, for convenience of description, the content corresponding to a webcomic will be used as an example. Here, a webcomic refers to a combination of “web” and “comics,” meaning cartoons or comics provided through an Internet communication network.

Such content may be composed of a plurality of sub-content. A plurality of sub-content may make up a series of the content.

Here, a series may refer to sequentially planned works or content.

In the present description, to avoid confusion between “content” and “sub-content,” the term “sub-content” will be referred to as “episode.”

In the present description, “using (consuming or viewing) content” may be understood as using (consuming or viewing) an episode.

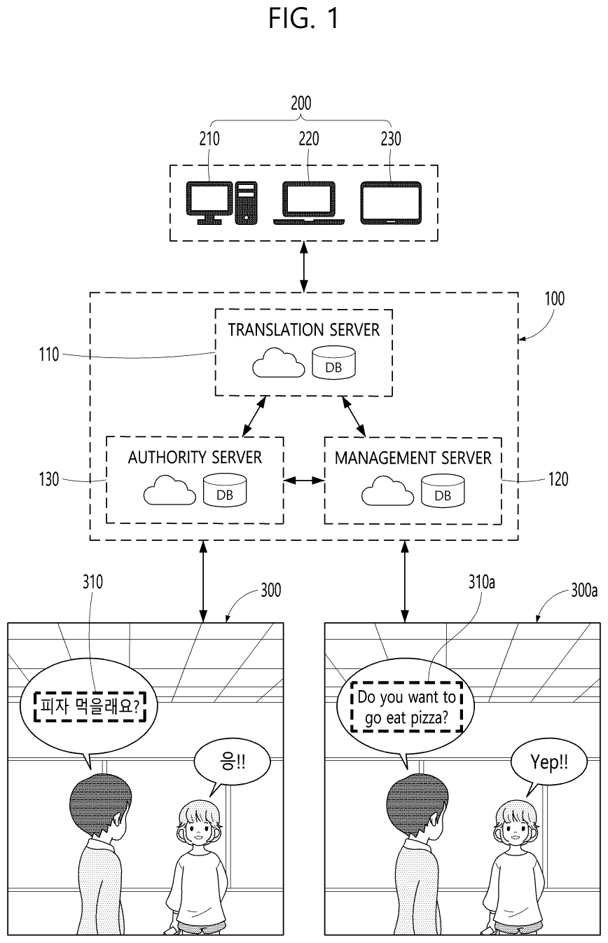

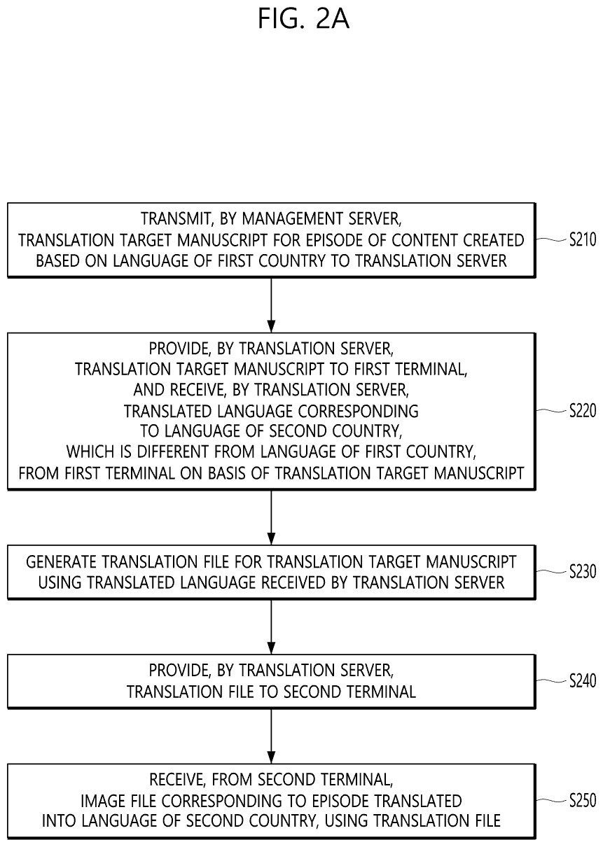

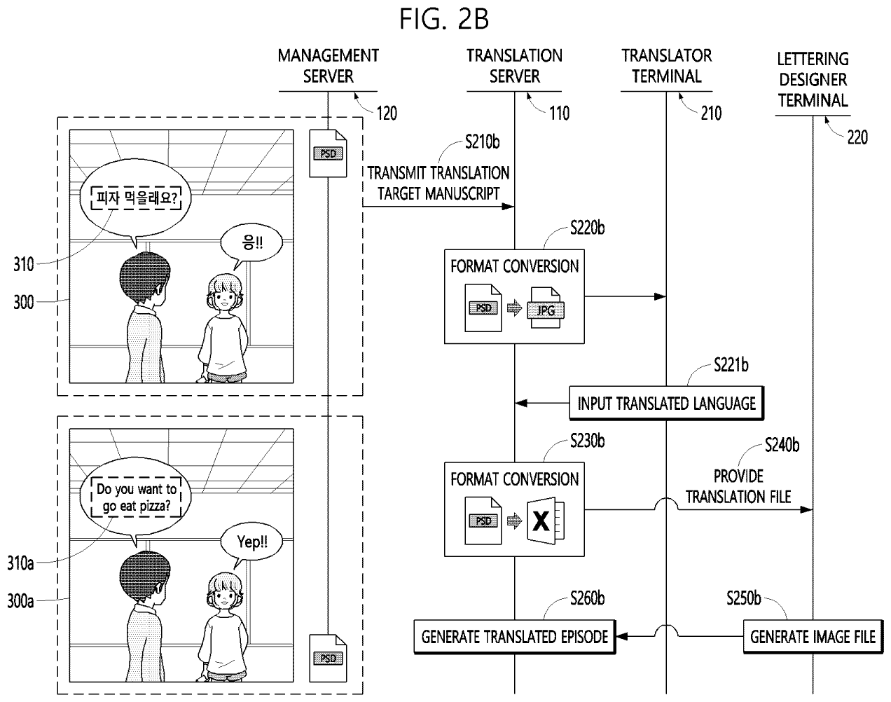

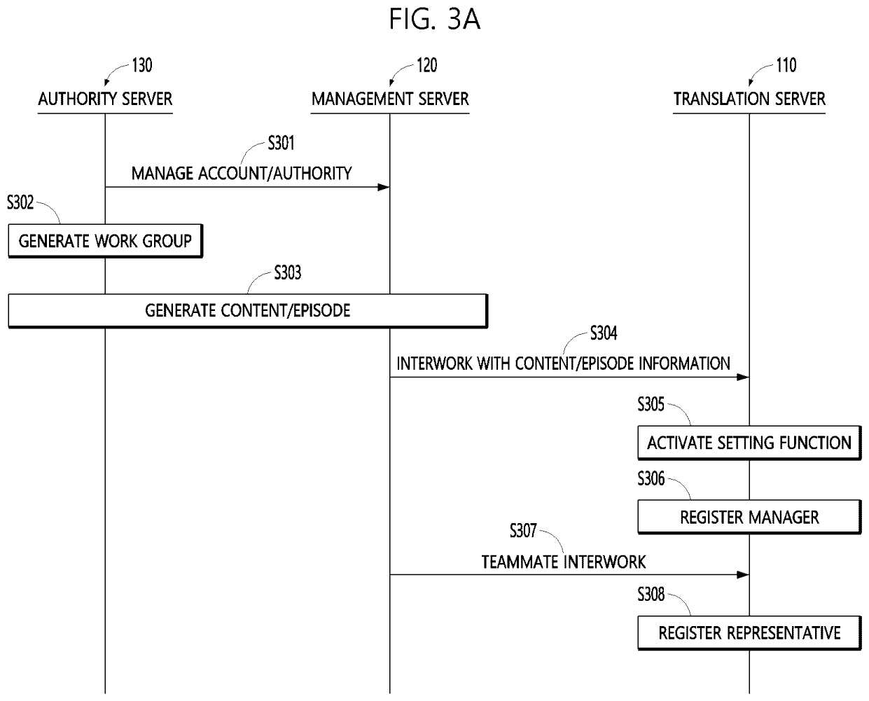

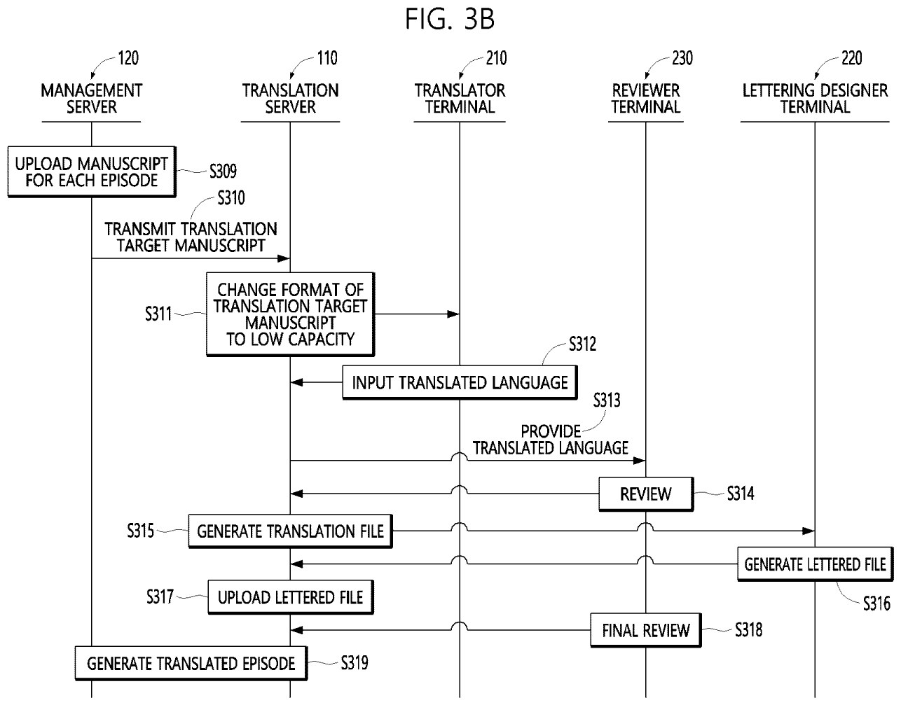

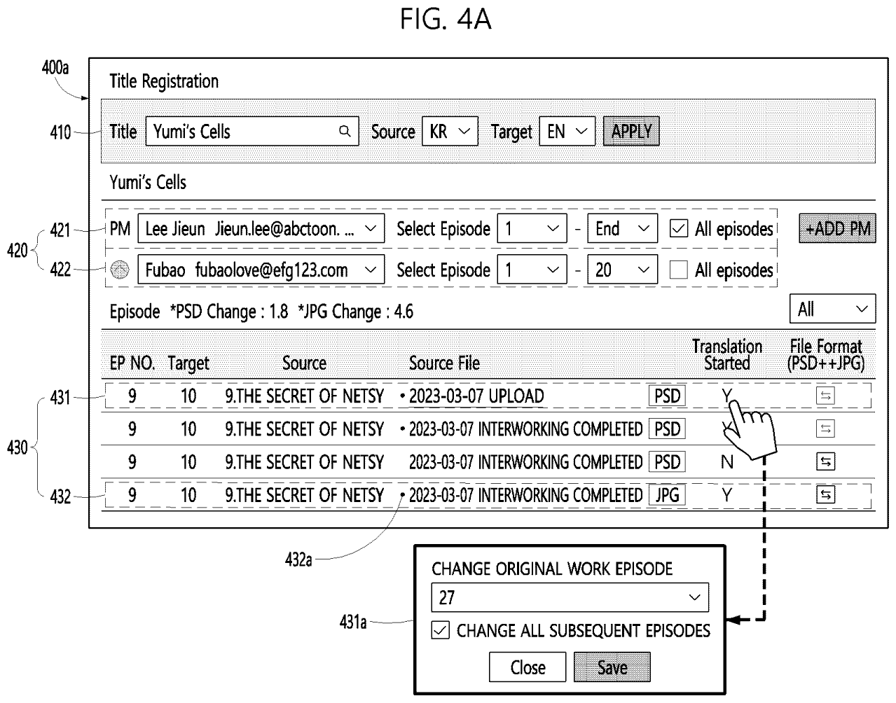

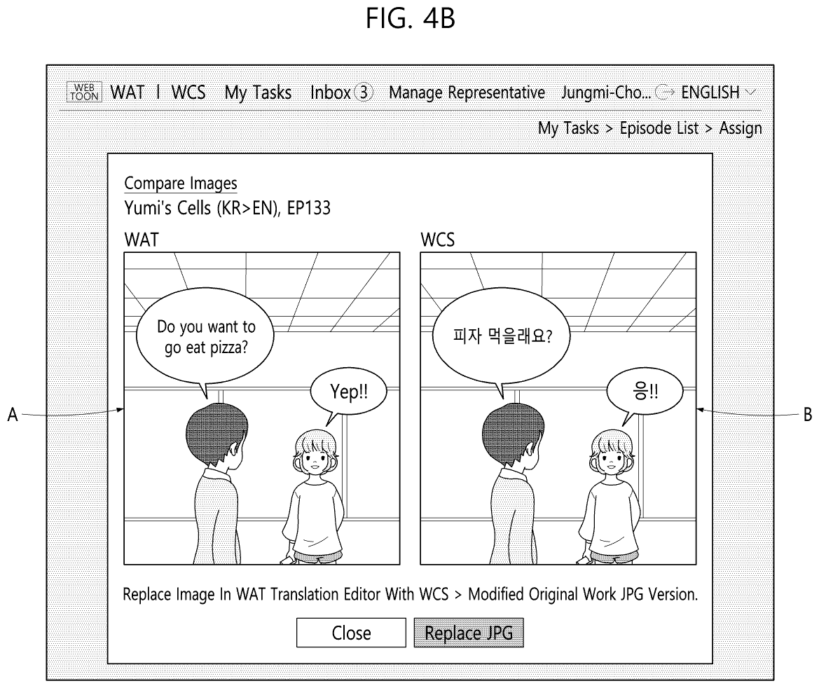

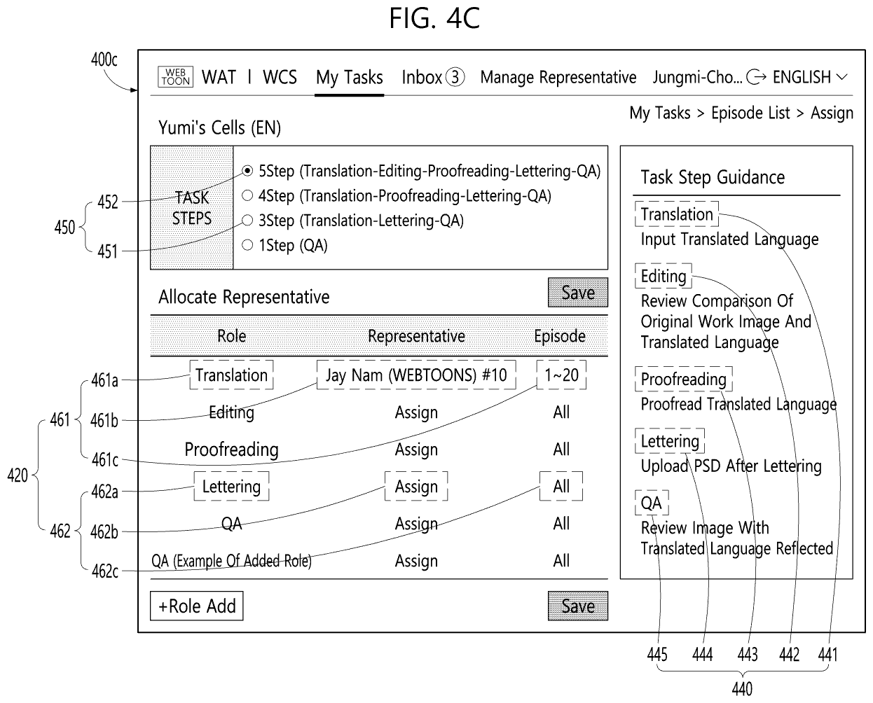

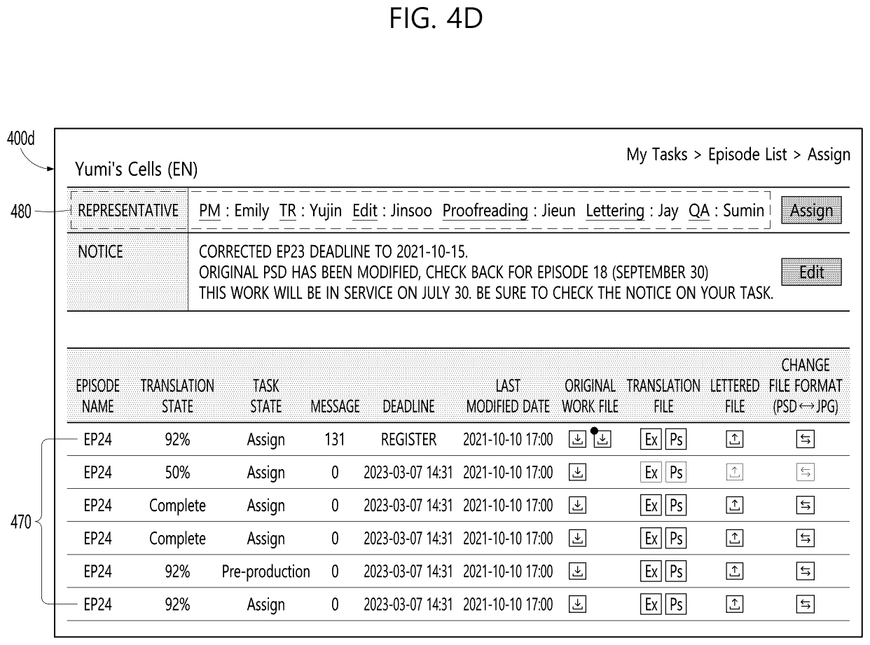

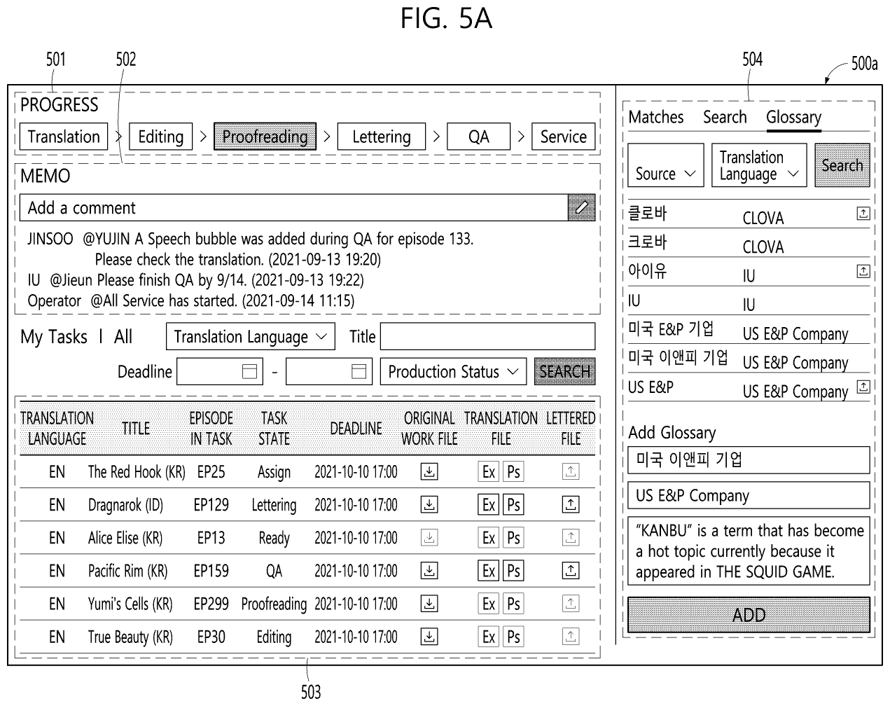

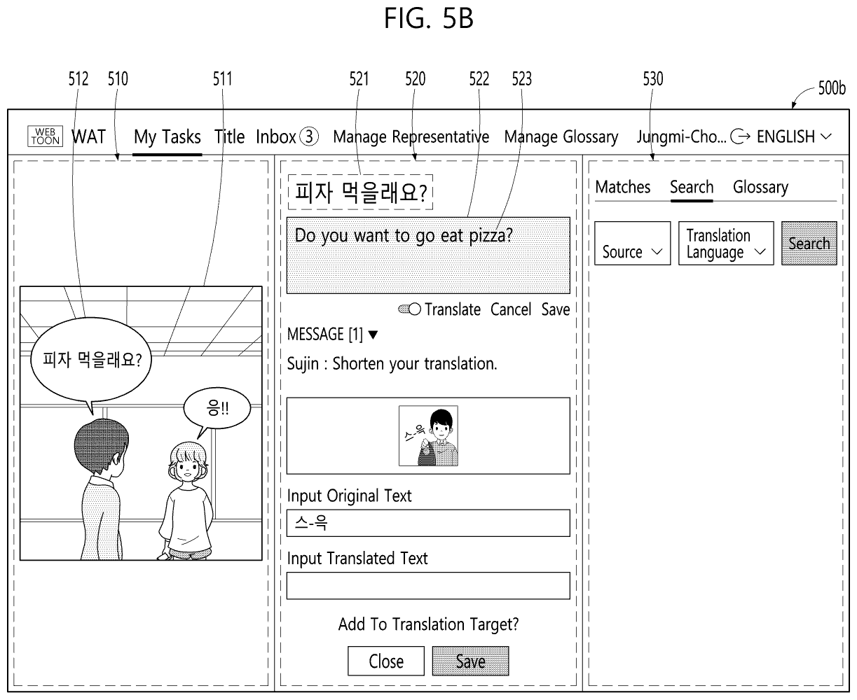

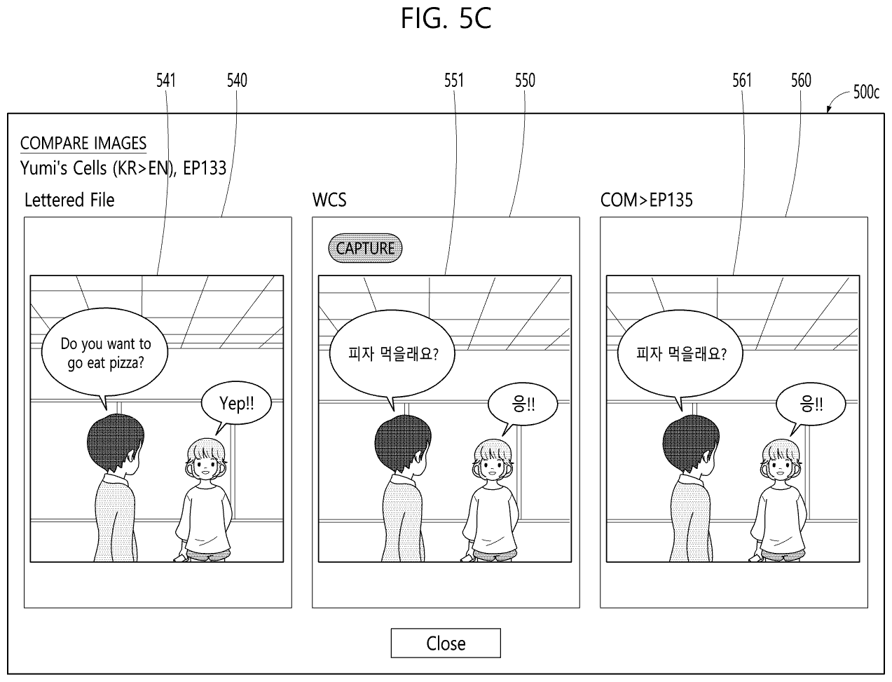

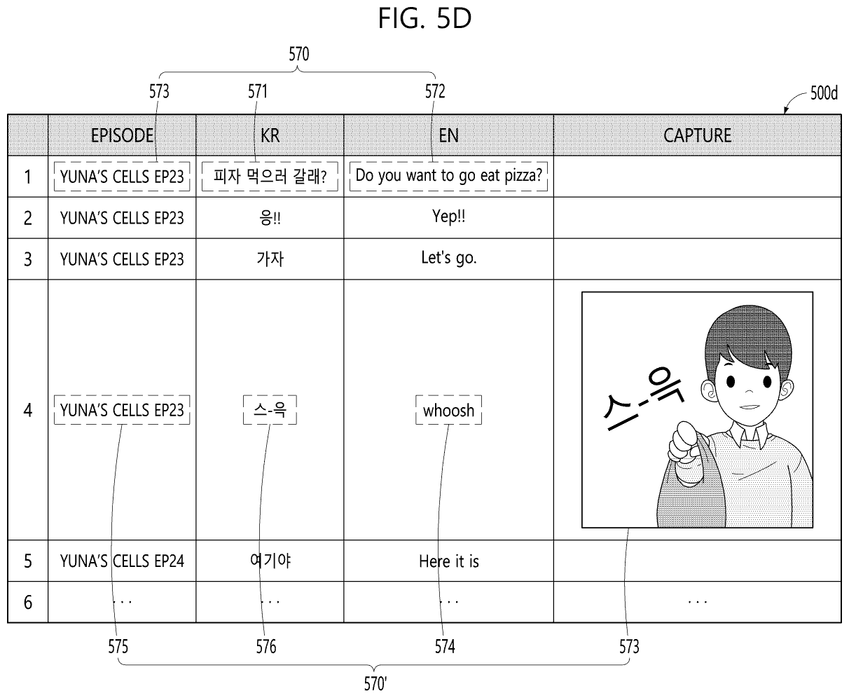

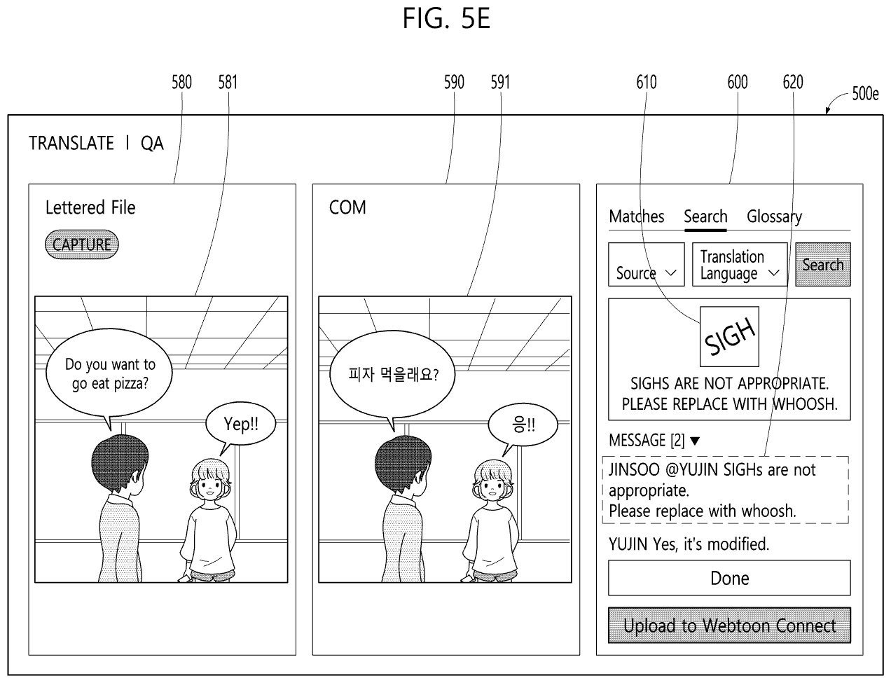

Hereinafter, a method of providing content to a user will be specifically described with reference to the attached drawings. FIG. 1 is a diagram for explaining a system for providing content translation according to one embodiment of the present invention. FIG. 2A and FIG. 2B are flowcharts for explaining a method of providing content translation according to one embodiment of the present invention, FIG. 3A and FIG. 3B are flowcharts for explaining data flow according to a method of providing content translation in certain embodiments of the present invention, FIG. 4A, FIG. 4B, FIG. 4C, and FIG. 4D are diagrams for explaining an operator account and a manager account according to certain embodiments of the present invention, and FIG. 5A, FIG. 5B, FIG. 5C, FIG. 5D, and FIG. 5E are diagrams for explaining translation processes according to certain embodiments of present invention.

As illustrated in FIG. 1, a system 100 for performing content translation may translate an episode 300 of content, which has been created based on the language of a first country (e.g., Korean, “ [symbol] ?”, 310), into the language of a second country that is different from the first country (e.g., English, “Do you want to go eat pizza?”, 310a), as shown by translated episode 300a.

Here, the “language of a first country” refers to a translation target language (original work language or source language), and the “language of a second country” may refer to the language of another country into which the language of the first country is translated (or target language).

The system 100 for providing content translation performs a task of translating the language of a first country (e.g., Korean, 310) included in a content episode into the language of a second country (e.g., English, 310a), as well as the tasks of reviewing and lettering the translated language. In the present description, this will be referred to as a “translation process” or a “translation review process.” However, this is merely an example for translation purposes, and the language of the second country may be any one of various languages, such as Japanese, Chinese, Spanish, Arabic, Indonesian, Thai, and others. Further, while the present description provides an example of translating Korean into another language, it is also possible to translate another language into Korean or to translate between languages of different countries.

To provide such a translation process, the system 100 for providing content translation may include at least one of an authority server 130, a management server 120, and a translation server 110. The authority server 130, management server 120, and translation server 110 may be configured to transmit and receive various information related to content provision or content translation operations through wired or wireless communication. The transmission and reception of information may be performed by a communication unit 210 included in each server 110, 120, or 130.

Here, a server, such s the authority server 130, the management server 120, the translation server 11, etc., may be a computer system, including a computer processor, that is configured to perform various function, such as providing information or services through a network. Each server may be configured to exchange various information or data with other servers or user terminals. The authority server 130 may be configured to perform a role of managing authority for at least one of user accounts or content registered in the management server 120. The authority server 130 may receive a request for assigning authority or may assign authority on the basis of a specific condition being satisfied by a user account registered in the management server 120.

For example, the authority server 130 may assign an operator account, which holds the authority to operate the translation process, to a specific user on the basis of an operator account assignment request. As another example, the authority server 130 may register a specific user account, which is registered in the management server 120, as a manager who holds the authority to designate a representative for the translation process (e.g., translator, lettering designer, reviewer, etc.), on the basis of a request from an operator account.

The management server 120 may be configured to perform roles related to content provision and the management of content translation operations. The management server 120 may store original content (or original work content) received from an author, and on the basis of the original content, the management server 120 may provide the original content to the translation server 110 to carry out the translation process. In this case, the management server 120 manages user accounts and authority related to translation and performs the function of providing a source file of a translation target, as original content, to the translation server 110.

The system 100 may transform the file format of content episodes in various ways in the translation process and provide them to representatives.

For example, when an original episode image file received from the author is a high-capacity first type of file, the high-capacity file may be converted into a low-capacity second type of file, which is then provided to the translation representative. As another example, when the original episode image file is a low-capacity second type of file, it is also possible to convert the low-capacity second type of file into a high-capacity first type of file.

The high-capacity first type of file may be, for example, a photoshop document (PSD) file, a Clip file (clip studio file), etc., while the low-capacity second type of file may be, for example, a JPG or PNG file, etc. However, embodiments of the present invention are not limited to the examples of the first type and the second type of file, and they may be transformed into various forms. For example, as technology advances, other types of files may be considered as the high-capacity files presented as examples, in addition to PSD files or Clip files. In addition, as the low-capacity file, different types of file than those discussed herein may be utilized.

Further, in certain embodiments of the present invention, to allow the lettering representative to intuitively recognize a translated language and a lettering task position, a third type of file in which a first language is matched with the translated language of the first language may be provided to a lettering designer. The third type of file may be, for example, a document file. The document file may be, for example, an Excel file or a Word file, and may be transformed into various forms. Hereinafter, a case where the third type of file is an Excel file will be described as an example.

The management server 120 may manage various types of files generated in the translation process by mapping (or matching) the various types of files to each other, with respect to original content episodes. Such mapped information may be used to review whether the translation is correct by comparing the translated output with the original content.

The translation server 110 may perform the role of providing a customized environment to each representative so that the translation process, from the setting of representatives of the translation process to translation, lettering, and review tasks, may be performed.

The translation server 110 may set task steps (or task processes) and task representatives for the translation process of a specific episode through designation by an operator account or a manager account.

In embodiments of the present invention, tasks included in the translation process may include at least one of i) a translation (or inputting translated language), ii) an editing review in which a translated language is modified and input, iii) a proofreading review, which uses messages on the translated language to provide feedback, iv) lettering, which changes the characters of an original content episode into the translated language, or v) an image review, which verifies whether an image reflects the translated language.

In the operator account or manager account, representatives for the translation process of a content episode may be designated on a task-by-task basis (a task-unit basis) (e.g., translation task-‘representative A’, lettering task-‘representative B’), while deadlines may be designated on an episode basis.

The translation server 110 may provide a translation editor (a translation tool that allows each task included in the translation process to be proceeded) to a terminal 200 of a translation process representative (or representative account or user account of the representative). Such a translation editor may provide translation support tools (e.g., memory, glossary) as well as features (image review, file format conversion, inbox messages, feedback, image comparison function, and the uploading of translated episodes after the completion of lettering tasks).

The system 100 for providing content translation according to certain embodiments of the present invention may be connected to at least one terminal 200 via wired or wireless communication. As illustrated in FIG. 1, the terminal 200 refers to an electronic device, and may be a smartphone, notebook computer, laptop computer, slate PC, tablet PC, ultrabook, desktop computer, and the like, without limitation on types. The service provided in certain embodiments of the present invention may be used through the terminal 200 logged in with a user account registered on the management server 120. For example, a translator responsible for the translation of an episode may be provided with a translation editor through a terminal 210 (which also may be referred to as a translator terminal) logged in with his or her user account, and may proceed with a task of translating the language of a first country included in the episode into the language of a second country using various functions provided in the translation editor. As another example, a lettering representative (lettering designer), responsible for lettering (sketching, drawing, or designing) a translated language into an episode, may be provided with a translation file using a terminal 220 (which also may be referred to as a lettering designer terminal) logged in with his or her user account. Accordingly, in the description provided herein, the terms “user,” “representative (e.g., translator),” “user account (e.g., translator account),” and “terminal (e.g., translator terminal)” may be used interchangeably.

As illustrated in FIG. 2A, a process of transmitting a translation target manuscript for an episode of content created based on the language of the first country from the management server to the translation server may proceed (S210).

As described above, the original content (or original work content) may exist to be stored in the management server 120, and on the basis of at least one episode of the original content being specified as a translation target, the management server 120 may provide a file of the specified episode as a translation target manuscript to the translation server 110.

In this case, the management server 120 may transmit a first type of file (e.g., PSD, Clip, etc.) including a plurality of layers to the translation server 110 (S210b, see FIG. 2B).

The first type of file may have layers separated by different elements (e.g., background, character, text, speech bubbles, etc.), and the management server 120 may provide the first type of file to the translation server 110 so that changing the language of the first country to the language of the second country may be done more easily.

In certain embodiments of the present invention, a process in which the translation server provides a translation target manuscript to a first terminal and receives, from the first terminal, a translated language corresponding to the language of a second country, which is different from the language of a first country, on the basis of the translation target manuscript, may proceed (S220, see FIG. 2A).

The translation server 110 may identify a translation representative of a translation target manuscript and provide the translation target manuscript to the first terminal 210 (translator terminal) logged in with a translation representative account.

Matching information on translation process representatives (e.g., a translation representative, a lettering design representative, etc.) for a specific episode may exist in the database (DB), which is stored in the computer memory of the translation server 110. A representative may be designated by a manager, and the translation server 110 may refer to the database (DB) to provide information necessary for tasks to representatives corresponding to the process in which the translation is being carried out. The details regarding the designation of a representative by a manager will be described below.

The translation server 110 may convert the first type of translation target manuscript into a second type of file, which is different from the first type, and provide the second type of file to the first terminal 210 (translator terminal) (S220b, see FIG. 2B).

For example, the translation server 110 may be configured to allow a file format to be changed in the operator account and manager account, depending on a file format type obtainable from a content writer or on a file format type that is more suitable for translation. Hereinafter, an example will be provided of a process of converting a high-capacity file of a first type into a low-capacity file of a second type. However, this is merely an example, and it is also possible to convert a low-capacity file into a high-capacity file as needed. In such a case, the management server transmits the second type of translation target manuscript to the translation server, and the translation server may convert the second type of translation target manuscript into the first type of file, which is different from the second type, and provide the converted first type of file to the first terminal.

Additionally, as described above, the first type of file may be, for example, a photoshop document (PSD) file, a Clip file (clip studio file), etc., but such a file type may be substituted for various other types of files. In addition, the low-capacity second type of file may be, for example, a JPG or PNG file, but this may also be substituted for various other types of files.

The first type of file (e.g., PSD, Clip, etc.) is composed of a plurality of layers, which makes it easy to be modified, but it may be a high-capacity file. Since the translation representative is not responsible for carrying out modification tasks on the translation target manuscript, a high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

The translation server 110 may provide the first terminal 210 (translator terminal) with a translation editor that includes the translation target manuscript converted into the second type of file. As described above, the translation editor is an interface (such as a graphical user interface, or GUI) for an efficient task environment for representatives, and further details will be described below.

On the first terminal 210 (translator terminal), the translation target manuscript converted into the second type of file is displayed, and a translated language (e.g., “Do you want to go eat pizza?”, 310a) corresponding to the language of the first country included in the translation target manuscript (e.g., “ [symbol] ?”, 310) may be input. The translation server 110 may receive the translated language on the basis of the translated language being input into the first terminal 210 (translator terminal) (S221b, see FIG. 2B).

Further, in the described embodiment of the present invention, a process of generating a translation file for the translation target manuscript using the translated language received by the translation server may proceed (S230, see FIG. 2A).

The translation server 110 may generate a translation file for the translation target manuscript using the translated language received from the first terminal 210 (translator terminal).

In this example of the present invention, the “translation file” may refer to a file provided to the lettering design representative responsible for a lettering task of the translated language.

A lettering designer, on the basis of the translation file, may be responsible for a task of changing the language of the first country to the language of the second country on a character layer among the plurality of layers in the translation target manuscript. The lettering designer needs to input (create, design, or sketch) the translated language in an area where the language of the first country was positioned, and it is very important for the lettering designer to intuitively recognize a matching relationship between the language of the first country and the language of the second country, which is the translated language.

The translation server 110 may generate a translation file in which the language of the first country and the translated language of the second country are each matched, so that the lettering designer may intuitively recognize the relationship between the language of the first country and the translated language corresponding to the language of the first country (see FIG. 5D, described below).

In this case, the translation server 110 may generate the translation file as at least one of a first type of file (e.g., PSD, Clip, etc.) or a third type of file (e.g., Excel) (S230b, see FIG. 2B). That is, the translation server 110 may set different formats of image files for the first terminal 210 (translator terminal) and the second terminal 220 (lettering designer terminal), and provide the translation target manuscript accordingly. Therefore, representatives may be provided with files in a format optimized for their tasks.

Further, the translation server may provide the translation file to the second terminal (S240, see FIG. 2A).

The translation server 110 may identify a responsible lettering designer for the translation target manuscript by referring to the database (DB), on the basis of the process in which the translation is being carried out corresponding to a lettering process. The translation server 110 may transmit the translation file to the second terminal 220 (lettering designer terminal) logged in with the account of the responsible lettering designer. For example, the translation server 110 may provide both the first type of translation file (e.g., PSD, Clip, etc.) and the third type of translation file (e.g., Excel) to the second terminal 220 (lettering designer terminal) (S240b, see FIG. 2B), and the lettering designer may proceed with the lettering task by selecting a desired type of translation file between the first type and the third type.

The translation process preferably further includes a “review” task process, and the review task may further include an editing review and a proofreading review performed between the translation task and the lettering task, as well as an image review performed after the lettering task. Further details regarding the entire process, including the review process, will be described below.

In this example of the present invention, a process of receiving an image file corresponding to the episode, translated into the language of the second country using the translation file, from the second terminal may proceed (S250, see FIG. 2A).

The translation server 110 may provide the second terminal 220 (lettering designer terminal) with the translation file and the first type of translation target manuscript file.

In the second terminal 220 (lettering designer terminal), on the basis of the translation file, the task of changing the characters of the language of the first country included in a character layer among the plurality of layers that make up the translation target manuscript file to the translated language, which is the language of the second country may be carried out. In the second terminal 220 (lettering designer terminal), an image file including the language of the second country may be generated (S250b, see FIG. 2B), and the translation server 110 may receive the image file.

In the image file received from the lettering designer terminal 220, the characters of the episode have been changed to the language of the second country, which is different from the first country, and in this example of the present invention, this may be referred to as a “lettered file.” In the translation server110, a translated episode for the content episode may be generated using the lettered file (S260b, see FIG. 2B).

The system 100 for performing content translation may operate a translation platform in linkage with the authority server130, management server 120, and translation server 110 to specify content works that require translation, set translation, lettering, and review representatives for the specified content, and ensure that tasks are carried out by the representatives according to the order of the tasks. Hereinafter, the entire translation process that proceeds in this example of the present invention, from specifying the work to reviewing, will be described.

As illustrated in FIG. 3A, the authority server 130 may manage user accounts and authorities (S301). The authority server 130 may assign an operator account, which holds the operation authority for the translation process, to a specific user on the basis of an operator account assignment request.

In the present specification, an “operator (or operator account)” may have authority over at least one of the following: designating managers, managing the translation target manuscript, managing translation process representatives, and managing translation support tools (e.g., glossary).

In the authority server 130, a work group may be generated (S302, see FIG. 3A). Further, on the basis of the work group generated in the authority server 130, at least one of the authority server 130 or the management server 120 may generate content and episodes based on the work group (S303, see FIG. 3A). In this example of the present invention, work groups, content, and episodes may be generated in sequence, and on the basis of the content and episodes being generated, information on the content and episodes may be linked to the translation server 110 (S304, see FIG. 3A).

In various embodiments of the present invention, information on the content and episodes may vary widely. As described above, the content may be made up of a plurality of episodes, and episode information according to a predefined order (e.g., upload order) may exist to be matched with the plurality of episodes. For example, the plurality of episodes that make up a specific content titled “Yuna's Cells” may have episode information matched according to the upload order, such as Episode 1 (ep. 1), Episode 2 (ep. 2), and Episode 3 (ep. 3). In certain embodiments of the present invention, various types of information, such as content (e.g., content title information), episodes making up the content (e.g., episode files), and episode numbers, are matched with each other. In the management server 120 and translation server 110, the information on the content and episodes may continuously be linked and updated.

When the content and episodes are generated in the management server 120, a setting function (or title registration function) for registering the translation target content may be activated in the translation server 110 (S305, see FIG. 3A).

As illustrated in FIG. 4A, a service page 400a provided to the operator account may include translation target content and a setting function (or setting function area 410) for setting the types of languages for the first country and the second country for the translation target content. The translation server 110, through the setting function 410, may receive content title information (e.g., “Yumi's Cells”), information on the type of language for the first country for the content (or original work language code, e.g., KR), and information on the type of language for the second country (or translated work language code, e.g., EN). The translation server 110 may specify translation target content (e.g., “True Beauty”, shown within the setting function area 410) and the first country language and second country language of the translation target content on the basis of the information received through the setting function 410.

In certain embodiments of the present invention, episode information on the content episode interwork with each other in the management server 120 and the translation server 110, and a change in episode information may be configured to be set in the operator account. Accordingly, in certain embodiments of the present invention, episode information on episodes in the translation server 110 may be updated when episode information on episodes in the management server 120 is changed, or may be changed by the operator account. Hereinafter, a case in which episode A, episode B, and episode C are included in the original work content and episode information on “Ep1”, “Ep2”, and “Ep3” are matched, respectively, will be described as an example.

In interworking with the change of episode information on episodes A, B, and C in the management server 120 to “Ep4”, “Ep5”, and “Ep6”, respectively, episode information on episodes A, B, and C in the translation server 110 may also be automatically updated to “Ep4”, “Ep5”, and “Ep6”, respectively.

Further, when episode information on episodes A, B, and C in the management server 120 is changed to “Ep4”, “Ep5”, and “Ep6”, respectively, the translation server 110 may transmit notification information notifying of the change in episode information to an operator account. The operator account that has identified the notification information may change episode information on episodes in the translation server 110 so as to correspond to episode information on episodes in the management server 120. For example, as illustrated in FIG. 4A, the translation server 110 may provide a pop-up window 431a matching the change function of episodes, when an item 431 corresponding to a specific episode of any one of a plurality of episodes included in a translation target episode list is selected on the operator terminal. The translation server 110 may change episode information on at least one episode among the translation target episodes based on receiving the request of changing the episodes through the pop-up window 431a.

The translation server 110 may change all episode information on episodes following a specific episode, including the selected specific episode. In this case, when there is a specific episode among the following episodes for which translated language has been received from a translator terminal, the translation server 110 may restrict a change in episode information starting from the specific episode. For example, when the selected specific episode is “Ep3,” the translation server 110 may sequentially change episode information on the following episodes such as “Ep3,” “Ep4,” and “Ep5.” In addition, when there is translated language for episode “Ep8,” the translation server 110 may change only episode information up to episode “Ep7,” and restrict a change in episode information starting from episode “Ep8.”

Further, interworking with the removal of episode information mapped to a specific episode in the management server 120, episode information mapped to the specific episode may also be removed in the translation server 110. In addition, the translation server 110 may also remove episode information mapped to the specific episode in response to a request for removing the episode information from the operator account.

Meanwhile, the management server 120 may modify the episode file of content. The episode modification in the management server 120 may be performed in various ways. For example, at least a part of the episodes may be changed, or an existing episode file may be replaced with another file.

The translation server 110 may replace the translation target manuscript existing in the translation server 110 to correspond to the modified episode by interworking with the modification of the episode in the management server 120. The translation server 110 may receive the translation target manuscript corresponding to the modified episode by the management server 120 and replace the existing translation manuscript with the modified translation target manuscript.

In this case, the translation server 110 may determine whether to replace the translation target manuscript based on different criteria depending on whether or not the translated language for the episode is received from the translator terminal (or the first terminal, 210).

If the translated language for the episode is not received, the translation server 110 may automatically replace the existing translation target manuscript. Contrary to this, when the translated language for the episode is received, the translation server 110 may transmit notification information notifying of the modification of the translation target manuscript to the operator account. For example, as illustrated in FIG. 4A, a specific graphic object (ex: Green Dot, 432a) may be displayed in an area of an item 432 corresponding to the modified translation target manuscript.

The translation server 110 may replace the translation target manuscript in response to receiving a request for replacing the translation target manuscript from the operator account. When the specific graphic object 432a is selected from the operator account, the translation server 110 may provide the translation target manuscript before modification (existing image, A, FIG. 4B), and the translation target manuscript after modification (modified image, B, FIG. 4B) to the operator account. The operator account may compare the translation target manuscript (A, FIG. 4B) before modification and the translation target manuscript (B, FIG. 4B) after modification, and then determine whether to replace the translation target manuscript.

The operator account preferably includes the authority to register managers, and in the translation server 110, on the basis of receiving a manager registration request for a specific user account from the operator account, the specific user account may be registered as a manager (S306, see FIG. 3A).

In certain embodiments of the present invention, the manager may set task processes and task representatives for the translation process of an episode.

As illustrated in FIG. 4A, the translation server 110 may receive a manager registration request, including information 420 on a specific user account, from the operator account through the service page 400a. The manager registration request may include the manager's name. In addition, in case that the registration of a plurality of managers is requested for a single content, the manager registration request may include information in which the names of each of the plurality of managers are matched with episodes that managers are responsible for.

The translation server 110 may register the task processes and task representatives for the translation process of an episode by setting the task processes and task representatives through either the operator account or the manager account (S308, see FIG. 3A).

In certain embodiments of the present invention, depending on whether the task representative registration is carried out by the operator account or the manager account, the management server 120 and the translation server 110 may proceed with interworking between user accounts (Teammate interwork) (S307, see FIG. 3A).

In the management server 120 and the translation server 110, when a representative registration request is received from the operator account, the requested user may be registered as a representative without the user account interworking process. In contrast, in the management server 120 and the translation server 110, the registration of a representative may proceed only for user accounts that are interworked with the manager account. The management server 120 and the translation server 110 may proceed with the registration of a representative only after interworking with the user account through a Teammate invitation when the manager account and the corresponding user account are not already in an interwork relationship.

Hereinafter, for convenience of description, an example will be provided in which the representative registration is carried out by the manager account, and user account interworking between the manager and the representative has been completed.

In this example of the present invention, the translation process may include at least one of a plurality of task processes, and the translation server 110 may provide a translation task interface (such as a graphical user interface, or GUI) corresponding to a task process to the representative terminal of the task process.

As illustrated in FIG. 4C, the task process (or task step, 440) included in the translation process in the embodiment of the present invention described herein may include at least one of i) translation (or inputting translated language, Translation, 441), ii) an editing review (Editing, 442) in which the translated language is modified and input, iii) a proofreading review (Proofreading, 443) which uses messages on the translated language to provide feedback, iv) lettering (Lettering, 444), which changes the characters of the original content episode into the translated language, or v) an image review (QA, 445), which verifies an image reflecting the translated language.

The translation server 110 may configure the translation process to include at least one of the plurality of task processes 441 to 445 by the manager account. In the manager account, the translation process may be configured in various ways based on episodes, translation companies and other factors.

For example, as illustrated in FIG. 4C, the translation server 110 may configure the process to include only translation, lettering, and image review tasks (Translation—Lettering—QA, 451), or configure the process to include all tasks such as translation, editing review, proofreading review, lettering, and image review (Translation—Editing—Proofreading—Lettering—QA, 452).

The translation server 110 may specify the representative for the task process on the basis of the task process for the episode of the content being specified. The translation server 110 may match the task process (e.g., Translation, 461a), the representative (user account, 461b), and the assigned episode (episodes 1-20, 461c), and store them in the database as a representative dataset 461. The translation server 110 may configure a representative dataset 461 or 462 for each task process of an episode on the basis of the information received from the manager account and store the representative dataset in the database. Further, in the process in which the translation is being carried out for an episode, the translation server 110 may refer to the database to identify the representative for the current task process.

As illustrated in FIG. 4D, the manager account may be provided with a management page 400d related to managing the translation process of an episode. The manager may perform overall task management of the translation process, management for the representatives, and management for deadlines through the management page 400d. To this end, the management page 400d may include a list of translation target content 470 allocated to the manager account, information on each representative for the task processes of the translation process 480, information on the task progress status for each episode, a deadline setting function, functions for registering and modifying notices, and a file upload function, and the like.

Further, the manager account may have the authority to change episode information on the episode and replace the translation target manuscript. In this case, the described embodiment of the present invention may be configured to change episode information on the episode and replace the translation target manuscript by at least one of the operator account and the manager account. Since the method of replacing episode information on the episode and the translation target manuscript is the same method as that of the operator account, a detailed description thereof will be omitted.

As illustrated in FIG. 5A, the translation server 110 may provide an editor 500a to each representative terminal of the task process included in the translation process. The editor 500a is an interface (such as a graphical user interface, or GUI) that may be used to perform the translation process task, and may include at least one of i) a task progress area 501 that indicates the current task process (or task state) and the representatives for each task process, ii) a memo area 502 that displays task-related memos or communication messages between the task representatives, iii) a content list area 503 that displays the translation target content allocated to the representatives, and iv) a translation support tool area 504 such as a glossary.

Further, the translation server 110 may be configured to provide a translation editor differently, based on the task in charge of the representative. Hereinafter, the entire translation process will be described in the order of translation (Translation)-editing review (Editing)-proofreading review (Proofreading)-lettering (Lettering)-image review (QA), and the translation editor provided to the representatives of each task process will also be described.

First, in the management server 120, the upload of the translation target manuscripts for each episode of the content may be carried out (S309, see FIG. 3B). For example, the management server 120 may receive a translation target manuscript from a writer account (or writer terminal) that creates the content episodes and upload the translation target manuscript to the database of the management server 120. As another example, the management server 120 may receive a translation target manuscript from a content upload representative account (or representative terminal) and upload the translation target manuscript to the database of the management server 120. In the present invention, the method by which the translation target manuscript is uploaded to the management server 120 may be diverse.

The management server 120 may transmit the translation target manuscript to the translation server 110 to proceed with the translation process for the translation target manuscript, in linkage with the translation server 110 (S310, see FIG. 3B).

In this case, the translation server 110 may change the file format of the translation target manuscript provided to the first terminal 210 (translator terminal) to a different format type. Such a file format may be converted by the operator account or the manager account as a more suitable type for translation.

For example, the translation server 110 may proceed with the task of converting the translation target manuscript received from the management server 120 into a low-capacity format (S311, see FIG. 3B). However, in this example, converting to a low-capacity format is merely an example, and it is also possible to convert to a high-capacity format as needed, or to make changes regardless of the file capacity on the basis of the translator's opinion or the like.

As described above, in this example of the present invention, content episodes may be configured as a first type of file that includes a plurality of layers. The first type of file may have layers separated by different elements (e.g., background, character, text, speech bubbles, etc.), and the management server 120 may provide the first type of file to the translation server 110 so that changing the language of the first country to the language of the second country may be done more easily. The first type of file is composed of a plurality of layers, which makes it easy to be modified, but it may be a high-capacity file. Since the translation representative is not responsible for carrying out modification tasks on the translation target manuscript, the high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

As illustrated in FIG. 5B, the translation server 110 may provide a translation editor interface (such as a GUI) 500b for the translation representative to the translator terminal. The translation editor 500b for the translation representative may include first to third areas 510 to 530. The first area 510 of the translation editor may display a translation target manuscript 511 having a low-capacity second type file format, and the second area 520 of the translation editor may display a text corresponding to the language (ex: “ [symbol] ?”, 521) of a first country extracted from the translation target manuscript 511. In addition, the third area 530 of the translation editor may output a translation support tool that recommends translated language for the text extracted from the translation target manuscript based on a database for the languages of the first country and the second country.

The translator terminal (the first terminal, 210) may input translated language corresponding to the language of the first country included in the translation target manuscript (S312, see FIG. 3B). As illustrated in FIG. 5B, the translation server 110 may activate and display an input window 522 for a text corresponding to the language (ex: “ [symbol] ?”, 521) of the first country in the second area 520. The translation server 110 may receive translated language (ex: “Do you want to go eat pizza?”, 523) as input for the text corresponding to the language (ex: “ [symbol] ?”, 521) of the first country through the input window 522.

Based on the reception of the translated language, the translation server 110 may match the received translated language with the text of the language of the first country corresponding to the translated language and store it in the DB. For example, when it is assumed that the language (“Do you want to go eat pizza?”) of the second country is received through the input window 522 corresponding to the language (“ [symbol] ?”) of the first country, the reviewer terminal 230 may match “ [symbol] ?” and “Do you want to go eat pizza?” with each other and store them in the DB. In this case, the translation server 110 may match information on content episodes from which the language of the first country is extracted and information on the text position on the episodes together and store them in the DB.

The translation server 110 may provide the text extracted from the translation target manuscript (or the original image corresponding to the translation target manuscript) and the translated language (or the image converted into the translated language) to the reviewer terminal 230 so that the translated language received from the translation representative terminal may be reviewed (S313, see FIG. 3B).

As described above, the review process for reviewing the translated language in the described embodiment of the present invention may include editing review for modifying and inputting the translated language, proofreading review for delivering feedback using a message for the translated language, and image review for performing the reviewing for the lettered file. The review task process described in the current process may correspond to the “editing review” task that modifies and inputs the translated language.

As described above, in embodiments of the present invention, various types of files generated during the translation process may be managed by mapping (or matching) them with each other based on the original content episode. This mapped information may be used to compare the translation results and the original content to review whether the translation is correct.

As illustrated in FIG. 5C, the translation server 110 may provide a comparison window (or a reviewing editor including the comparison window, 500c, which may be in the form of a GUI) for comparing episodes and translated language so that an editing review representative may review the translated language. In this case, the review comparison window 500c illustrated in FIG. 5C may be output in a pop-up form in the translation editor illustrated in FIG. 5B, and may be provided to the review representative by overlapping with a screen of the translation editor.

A first area 540 of the review comparison window 500c of FIG. 5C may output an image 541 in which the language of the first country in the episode is converted into the translated language, and a second area 550 of the review comparison window 500c may output an original image 551 of the episode.

In this case, the translation server 110 may control at least a part of the translation editor 500b output to the translation representative terminal and the review comparison window 500c output to the e review representative terminal to be able to interwork with each other. More specifically, the translation server 110 may output an image interworked with the image being output in the first area 510 of the translation editor 500b onto the first area 540 of the review comparison window 500c. For example, based on the reception of the translated language from the translator terminal 210, the translation server 110 may output images in which the language of the first country is converted into the translated language on the first area 510 of the translation editor 500b. In interworking with this, the translation server 110 may output images 541 in which the language of the first country in the translation editor 500b is converted into the translated language even on the first area 540 of the review comparison window 500c.

Meanwhile, in certain embodiments of the present invention, when a content episode file is received from an author, the administrator may manage the file. In this case, in certain embodiments of the present invention, both the file received from the author and the file managed by the administrator may be provided to the reviewer, thereby providing an environment wherein cross-reviewing is possible. In this specification, for the convenience of explanation, the content episode file received from the author may be referred to as the original image of the first attribute, and the content episode file managed by the administrator may be referred to as the original image of the second attribute. As illustrated in FIG. 5C, the translation server 110 may output the image 541 in which the language of the first country in the episode is converted into translated language in the first area 540 of the review comparison window 500c, output the original image 551 of the first attribute in the second area 550 of the review comparison window 500c, and output the original image 561 of the second attribute in the third area 560 of the review comparison window 500c, so that these images may be provided to the editing reviewer terminal 230. In this case, any one 551 of the original images of the first attribute and the second attribute may be an original image stored in the authority server, and the other 561 may be an original image stored in the service server that services the content episode to webcomic subscribers. The original image stored in the authority server and the original image stored in the service server may differ from each other due to resizing, etc.

The reviewer terminal 230 may compare the original image with the image displaying the translated language and perform an editing review by modifying the translated language (S314, see FIG. 3B).

Further, a proofreading review task, which uses messages on the translated language to deliver feedback to the translation representative, may proceed. A proofreading review representative may be the same user as an editing review representative or it may be a different user. The translation server 110 may transmit a message to the translator terminal on the basis of receiving the message including feedback information on the translated language from a proofreading reviewer terminal. The translation server 110 may display the feedback information received from the proofreading reviewer terminal in one area of the translation editor 500b. In this case, the translation server 110 may display the feedback information in the area surrounding the translated language (e.g., Do you want to go eat pizza?) that is the subject of the feedback.

The translation server 110 may generate a translation file for the translation target manuscript on the basis of the review of the translated language being completed (S315, see FIG. 3B).

The translation server 110 may update the translated language based on the reception of the modified translated language that reflect the review results from the translation terminal. In this case, the translation server 110 may generate a translation file for the translation target manuscript using the updated translated language.

In the described embodiments of the present invention, the “translation file” may refer to a file provided to the lettering design representative responsible for a lettering task of the translated language.

As illustrated in FIG. 5D, the translation server 110 may generate a translation file 500d including a data set 570 in which the language of the first country (ex: “ [symbol] [symbol] ?”, 571) and the translated language (ex: “Do you want to go eat pizza?”, 572) corresponding to the language of the first country are matched with each other. Further, the translation server 110 may configure the data set 570 by further matching information on an episode of content from which the language of the first country is extracted (ex: “Yuna's Cells Episode 23”, 573) and information on the position of a language extracted from the episode. Then, the translation server 110 may generate a translation file 500d using this data set 570.

When there is a text that is not extracted from the translation target manuscript, the translation representative may capture an area including the text and proceed with the translation task for the corresponding text. The translation server 110 may add the captured image to a translation target list based on the occurrence of a capture event in the translator terminal. The translation server 110 may receive translated language corresponding to the captured image from the translator terminal. As illustrated in FIG. 5D, the translation server 110 may configure a data set 570′ by matching at least a part of a capture image 573, translated language (whoosh, 574) corresponding to the text (ex: “ [symbol] ”) included in the capture image, information on the episode in which the image was captured (ex: “Yuna's Cell Episode 23”, 575), information on the position of the image captured on the episode, and the original text included in the capture image (“ [symbol] ”, 576). In addition, the translation server 110 may generate a translation file 500d using this data set 570′.

The translation server 110 may generate the translation file as at least one of a first type of file or a third type of file. The lettering designer needs to input (create, design, or sketch) the translated language in an area where the language of the first country was positioned, and it is very important for the lettering designer to intuitively recognize a matching relationship between the language of the first country and the language of the second country, which is the translated language. Accordingly, in the present invention, preferably, the translation file may be generated as a third type of file having a table structure and it may be provided to the lettering designer.

As illustrated in FIG. 5D, the translation file 500d having the third type file has the table structure, and a plurality of cells included in the table area may include the language of the first country and the language of the second country that are matched with each other.

In the second terminal 220 (lettering designer terminal), a lettered file may be generated using the translation file (S316, see FIG. 3B). In the second terminal 220 (lettering designer terminal), on the basis of the translation file, a task may be performed where the characters of the language of the first country, included in the character layer among the plurality of layers that make up the translation target manuscript file, are changed to the translated language, which is the language of the second country. The lettering designer terminal 220 may transmit and upload the lettered file to the translation server 110 (S317, see FIG. 3B). The lettered file may be configured as a first type of file consisting of a plurality of layers.

The translation server 110, upon the upload of the lettered file, may allow a final review of the lettered file to be conducted on the reviewer terminal 230 of the image review representative (S318, see FIG. 3B). Although FIG. 3B illustrates the reviewer terminal for the editing review, proofreading review, and image review (or final review) collectively as “reviewer terminal 230” without distinction, the representatives for the editing review, proofreading review, and image review (or final review) may be different, in this case, the reviewer terminals may also differ.

As illustrated in FIG. 5E, the translation server 110 may provide a QA editor 500e (in the form of a GUI) to an image reviewer terminal. The translation server 110 may output a lettered file image 581 of the content episode to a first area 580 of the QA editor 500e. In addition, the translation server 110 may output an original image 591 of the content episode to a second area 590 of the QA editor 500e. That is, the translation server 110 may output a translated episode image 581 in which the translated language (the language of the second country) is reflected to the first area 580 of the QA editor 500e, and output a translation target image 591 in which the language of the first country is displayed to the second area 590 of the QA editor 500e.

The image reviewer may perform a final review through the QA editor 500e to review whether the translation is correct and whether lettering of the translated language is done accurately.

Based on the occurrence of a capture event at the state where the lettered file image 581 is displayed in the first area 580 of the QA editor 500e, the captured image may be added as a review item 610 in a third area 600 of the QA editor 500e. A review message 620 for the review item 610 may be input through the reviewer terminal.

The translation server 110 may transmit the review message 620 to at least one of the translator terminal (the first terminal, 210) or the lettering representative terminal (the second terminal), based the receipt of the review message 620 for the review item 610 from the reviewer terminal. That is, in certain embodiments of the present invention, a process of performing review for the lettered file and transmitting the review message to the second terminal through the translation server may be performed.

On the basis of the final review of the translated episode having been completed, the translation server 110 and the management server 120 may generate a translated episode corresponding to the episode created based on the language of the first country by using the lettered file created based on the language of the second country (S319, see FIG. 3B).

As such, the system for performing content translation 100 according to embodiments of the present invention may translate the language of the first country included in the content into the language of the second country through various task processes such as translation, lettering, and reviewing, and generate translated content reflecting the language of the second country. By utilizing this translated content, it is possible to provide content services targeting various consumers in various countries beyond just providing content services in a specific country. The consumers may use the same content in their own language, and even if the languages the consumers use are different, they may form a sense of empathy and share culture.

The present invention preferably relates to a method of performing content translation and a system for performing the same and may provide the functions and the environment necessary for translation, lettering, and reviewing tasks of content in linkage with a content-providing service. Further, embodiments of the present invention relate to a method and system for performing content translation that may provide the functions of managing a communication tool (e.g., Inbox, Message) between the workers, translation, lettering, and reviewing task processes.

As described above, the method and system for performing content translation according to embodiments of the present invention may transmit a translation target manuscript for an episode of content created based on a language of a first country by a management server to a translation server. The management server plays a role in managing original content and providing it to the translation server, and may ensure that the translation process is consistently performed on the translation server based on the original content.

Further, the method and system for performing content translation according to embodiments of the present invention may provide the translation target manuscript to the first terminal by the translation server, and receive translated language corresponding to the language of a second country different from the language of the first country based on the translation target manuscript from the first terminal. A user of the first terminal may be provided with an efficient translation environment optimized for translation by the translation server, and the translation server may receive translation results translated from the language of the first country to the language of the second country from the first terminal.

Further, the method and system for performing content translation according to embodiments of the present invention may generate a translation file for the translation target manuscript using the translated language received by the translation server, and provide a translation file to the second terminal by the translation server. A user of the second terminal may intuitively recognize and match the translated language and an episode of the original content through the translation file, and perform a lettering task.

Further, the method and system for performing content translation according to embodiments of the present invention may receive an image file corresponding to the episode and translated into the language of the second country using the translation file from the second terminal, and provide contents translated into various languages to consumers.

Further, the embodiments of the present invention described above may be implemented as computer-readable code or instructions on a medium in which a program is recorded. That is, the embodiments of the present invention may be provided in the form of a program.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMS, CD-ROMs, magnetic tapes, floppy discs, and optical data storage devices.

Further, the computer-readable medium may be a server or cloud storage that includes storage and that the electronic device is accessible through communication. In this case, the computer may download the program according to certain embodiments of the present invention from the server or cloud storage, through wired or wireless communication.

Further, in the embodiments of the present invention described herein, the computer described above is an electronic device equipped with a processor, that is, a central processing unit (CPU), which is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of performing content translation, comprising:
transmitting, by a management server, a translation target manuscript for an episode of content created based on a first language to a translation server;
providing, by the translation server, the translation target manuscript to a first terminal, and receiving, from the first terminal, translated language corresponding to a second language, where the second language is different from the first language;
generating, by the translation server, a translation file for the translation target manuscript using the received translated language;
providing, by the translation server, the translation file to a second terminal; and
receiving, from the second terminal, an image file corresponding to the episode, which is translated into the second language using the translation file.

2. The method of claim 1, further comprising:
generating, by an authority server, a work group, the authority server assigning an operator account of the management server,
wherein the content and the episode are generated based on the work group in the operator account.

3. The method of claim 2, wherein in response to the content and the episode being generated by the management server, the translation server activates a setting function for setting language types of the first language and the second language in the operator account.

4. The method of claim 3, wherein a manager is registered to designate at least one user account of the first terminal and the second terminal through the setting function.

5. The method of claim 2, wherein episode information on the episode interworks between the management server and the translation server, and a change in the episode information is configured to be set in the operator account.

6. The method of claim 2, wherein in response to the episode being modified, the translation target manuscript is replaced based on different criteria depending on whether the translated language is received from the first terminal.

7. The method of claim 1, further comprising:
providing, by the translation server, a comparison window for comparing the episode and the translated language to enable a review of the translated language.

8. The method of claim 7, wherein the review of the translated language includes at least one of an editing review for modifying and inputting the translated language or a proofreading review for delivering feedback using a message for the translated language.

9. The method of claim 1, wherein the image file is a lettered file in which characters of the episode have been changed to the second language, and a translated episode for the episode is generated using the lettered file.

10. The method of claim 9, further comprising:
performing a review of the lettered file and transmitting a review message to the second terminal through the translation server.

11. The method of claim 1, wherein a file format type of the translation target manuscript provided by the translation server to the first terminal is changed to another format type.

12. The method of claim 11, wherein the translation server changes the file format of the translation target manuscript into a low-capacity format and provides the changed low-capacity format of translation target manuscript to the first terminal.

13. The method of claim 11, wherein the translation target manuscript is set as an image file of a different format between the first terminal and the second terminal.

14. A system for performing content translation, comprising:
a management server configured to register a translation target manuscript for an episode of content created based on a first language; and
a translation server configured to receive the translation target manuscript from the management server, and provide the translation target manuscript to a first terminal that translates the translation target manuscript into a second language, where the second language is different from the first language,
wherein the translation server receives a translated language corresponding to the language of the second language from the first terminal,
generates a translation file for the translation target manuscript using the received translated language and provides the translation file to the second terminal, and
receives an image file corresponding to the episode, which is translated into the second language, from the second terminal and transmits a translated episode for the episode to the management server.

15. The system of claim 14, further comprising:
an authority server configured to assign an operator account of the management server.

16. A non-transitory computer-readable recording medium storing a program that enables at least one server to execute steps comprising:
transmitting, by a management server, a translation target manuscript for an episode of content created based on a first language to a translation server;
providing, by the translation server, the translation target manuscript to a first terminal, and receiving, from the first terminal, translated language corresponding to a second language, wherein the second language is different from the first language;
generating, by the translation server, a translation file for the translation target manuscript using the received translated language;
providing, by the translation server, the translation file to a second terminal; and
receiving, from the second terminal, an image file corresponding to the episode, which is translated into the second language using the translation file.
